(19) United States
(12) Patent Application Publication
(10) Pub. No.: US 2024/0217704 A1
(43) Pub. Date: Jul. 4, 2024

(54) PAPER BAG

(71) Applicant: dy-pack Verpackungen Gustav Dyckerhoff GmbH, Wenden-Gerlingen (DE)

(72) Inventors: Wilhelm A. DYCKERHOFF, Drolshagen (DE); Eduard LISEK, Drolshagen (DE)

(21) Appl. No.: 18/561,915

(22) PCT Filed: May 6, 2022
(86) PCT No.: PCT/EP2022/062265

§ 371 Date: Nov. 17, 2023

(30) Foreign Application Priority Data
May 21, 2021 (DE) 20 2021 102 803.3

(51) Int. Cl. B65D 30/08; B65D 30/18; B65D 30/24; B65D 65/46

(52) U.S. Cl. CPC B65D 31/04; B65D 31/08; B65D 31/14; B65D 65/466

(57) ABSTRACT

The invention relates to a paper bag (10) for potting soil or comparable moist bulk materials, which paper bag is formed from a tubular piece (15) comprising at least two paper layers (20, 25, 30), the bonds of the bag (10) being formed with biodegradable adhesive, the innermost paper layer (20) of the tubular piece (15) having, on its outer face (22), a water-repellent coating, preferably a PE coating, and at least one of the paper layers (20, 25, 30) having, at least on its inner face (24, 27, 34), a darkening colouring, preferably a black colouring.

The invention relates to a bag for moist and biologically active bulk materials, such as potting soil. Standard commercial potting soil typically has residual moisture in the range of 20-25% by weight and is a biologically active and organic material, which makes it particularly demanding in terms of packaging.

Potting soil is commonly packaged in plastic bags, particularly those made of polyethylene (PE). Such bags are not environmentally friendly due to their plastic nature, which is noticeably undesirable.

Furthermore, paper bags are commonly used for the packaging of dry bulk materials. For the production of such bags, single or multi-layer paper webs are usually formed in a so-called tuber into an endless tube and singulated into tube pieces of suitable length, from which the bag is finally formed, e.g. by means of a cross or block bottom folding. During the bag production, the paper is bonded at suitable positions to fix the bag shape. However, the aforementioned paper bags are unsuitable for packaging moist bulk materials, partly because moisture from the filling material penetrates into the bag material and the bonds, impairing the strength and stability of the bag.

Against this background, it is the object of the present invention to provide an environmentally friendly paper bag for moist potting soil and similar bulk materials, which ensures sufficiently stable, easy-to-handle packaging. In this context, it is preferred to provide a paper bag for packaging, transportation and storage of bulk material with a residual moisture content in the range of 20-25% by weight, in which the properties of the filling material are retained as well as possible and, for example, molding or drying out is avoided.

According to the invention the object is achieved by a paper bag according to claim 1. Advantageous embodiments result from the sub-claims.

The paper bag according to the invention is formed from a tube piece comprising at least two paper layers. Advantageously, the paper bag is made of exactly two paper layers or exactly three paper layers. In the bag according to the invention, the bonds of the bag material typically required in bag production are implemented with a biodegradable adhesive. Thus, the bag as a whole becomes more friendly to the environment. According to the invention, the innermost paper layer of the tube piece has a water-repellent coating on its outer face facing away from the interior of the bag. In this respect, the coating can preferably be a PE coating. At least one paper layer has a darkening, preferably black, colouring at least on its inner face facing the interior of the bag. Within this meaning, darkening is any colouring that makes the paper darker in comparison to its natural color. On the inner face of a paper layer, for example, as darkening colouring, there may be dark or black ink printed. Advantageously, the darkening ink can be applied to the inner face of the innermost paper layer being in contact with the filling material.

The bag according to the invention enables environmentally friendly and at the same time stable packaging for moist bulk materials such as potting soil. In particular, it is possible to keep the plastic content below 5% so that the bag can be declared as a pure paper bag according to the relevant regulations. With dark or black printing on the inner face of a paper layer, biological activity of the filling material can be avoided or significantly reduced. The dark or black printing prevents light from penetrating inside the bag. This reduces biological activity in the filling material, which is stimulated by light. The effect is similar to covering biological material stored outdoors with a black silo film. This also reduces the biological activity of the covered material. Applying the water-repellent coating to the outer face of the innermost paper layer eliminates the need for such a coating on its inner face. As a result, the inner face can be bonded with conventional biodegradable adhesive. If this were not the case, there would be required a special adhesive of possibly non-biodegradable origin. Through the water-repellent coating on the outer face of the innermost paper layer, moisture is prevented from penetrating to any meaningful extent from the inside into the outer paper layers. As a result, the outer paper layers can be kept dry, providing strength and stability to the bag. Thus, a coating-free inner face of the innermost material layer enables good bonding of the bag, while the coating of the outer face prevents moisture penetration of further bag layers. Furthermore, the water-repellent coating prevents water from penetrating the bag interior and the filling material from the outside. This prevents the filling material from getting more soaked than when it was filled. Overall, therefore, on the one hand there can be prevented drying out of the filling material, and on the other hand there can be prevented greater moisture penetration of the filling material. This results in a stable and environmentally friendly paper bag for packaging, storage and transportation of potting soil and comparable moist bulk materials, wherein the residual moisture can be kept stable over the typically relevant time periods and other adverse changes in the filling material can be avoided.

Advantageously, the bag according to the invention has a bottom at one end of the tube piece, preferably a cross bottom, block bottom or pinch bottom.

Advantageously, an inner lining is placed in the bottom, which is typically at the bottom when the bag is carried, to reinforce the bottom. In the case of a cross bottom or block bottom, it is particularly advantageous if the inner lining is glued into the open bottom fold as a sheet-shaped material layer. Preferably, the inner lining is also made of paper to achieve high environmental friendliness. It is further preferred according to the invention that the inner lining is provided with a water-repellent coating, preferably a PE coating, on its outer face facing away from the interior of the bag. This also prevents in the bottom region that material layers outside the inner lining soak through from the inside. On the inner face of the inner lining facing the bag, a water-repellent coating can be omitted, thus enabling good bonding with biodegradable adhesive. In particular, this allows the inner lining to be glued with its side without a water-repellent coating over a larger surface area to the inner face of the innermost paper layer, which also has no water-repellent coating, thus achieving a particularly strong bottom bonding satisfying the stability requirements of the moist and heavy filling material. It is further preferred that the inner lining has an darkening, preferably black, colouring on its inner face facing the interior of the bag in order to better prevent light from entering in the region of the base. The darkening colouring can be made by printing with dark or black color.

Advantageously, the biodegradable adhesive contains starch glue, preferably potato starch glue. Starch glue, especially potato starch glue, is a comparatively inexpensive adhesive that ensures a good adhesive effect with paper. In a particularly preferred embodiment, the biodegradable adhesive consists entirely of pure starch glue. In another preferred embodiment, a moisture-stable bonding additive, preferably dispersion glue, is admixed to the biodegradable adhesive. The disadvantage of starch glue is that it dissolves to a certain extent due to moisture or water, and thus weakening the strength of the bond. This can be counteracted by adding a moisture-stable bonding additive. A moisture-stable bonding additive is an additive whose bonding effect does not decrease or decreases only slightly in the presence of moisture. Such a moisture-stable bonding additive can be, for example, an admixture of dispersion glue to a starch glue. Particularly advantageously, the moisture-stable bonding additive is admixed to the biodegradable adhesive with a content of not more than 10%, further preferably of not more than 7%. With such a content, on the one hand the amount of non-biodegradable adhesive can be kept at a low level. On the other hand, such admixture is sufficient to maintain a good adhesive effect even if there is a moistening of the bonding point.

According to another advantageous embodiment, the bonding regions of the bag material do not comprise any coatings reducing the adhesion. Typically, it is the water-repellent coatings, for example, that lead to a reduced adhesive effect of starch glue. In a preferred embodiment, it is therefore provided that the adhesive areas of the bag material are not provided with coatings of this type that reduce the adhesion of the adhesive. The recess of the bonding regions allows the remaining areas of the affected surfaces, e.g. the inner face of the innermost material layer, to be provided with a water-repellent and/or other type of coating.

In another embodiment, it is provided that bonding regions of the bag material provided with a coating reducing adhesion are bonded with a water-resistant adhesive component. Water-resistant adhesives typically achieve a good adhesive effect even on water-repellent coated surfaces. It is therefore particularly advantageous when such adhesive components are used in water-repellent coated regions.

In another preferred embodiment, the inner face of the innermost paper layer and/or the inner face of the inner lining is treated with a fungicide. Thus, molding in the bag material and in the filling material can be prevented. In this respect the fungicide is advantageously a natural fungicide. What is also advantageous is the application of a substance with antimicrobial effect.

In another preferred embodiment, the inner face of the innermost paper layer and/or the inner face of the inner lining is provided with an alkaline application. The potting soil is often acidic, that is, its pH is less than 7. The acid contained in potting soil can cause the sack paper to deteriorate or decompose. According to the invention, this can be counteracted with an alkaline application on the inner face of the innermost paper layer. The alkaline application can, for example, be applied in a brushing process. Also possible is an alkaline coating containing chalk or lime, e.g. by means of printing an aqueous chalk solution to the inner face of the innermost paper layer. Particularly preferably, the inner face of the innermost paper layer is provided with a darkening color, treated with a preferably natural fungicide and coated with an antimicrobial and alkaline agent. Alternatively, the darkening color can also be applied to the inner face of a material layer further out.

In another preferred embodiment, water-repellent paper coatings are arranged as coatings free of plastic. Such free-of-plastic coatings can be, for example, oils or greases. With such free-of-plastic water-repellent coatings, a higher environmental friendliness of the bags according to the invention can be achieved. Advantageously, the water-repellent paper coatings can also be biodegradable, compostable and/or recyclable.

It is particularly preferred that the bag according to the invention does, besides the material layers made of paper, not have any material layers made of any other material. Particularly preferably, the bag according to the invention is formed as a two-layer bag consisting of two paper layers or as a three-layer bag consisting of three paper layers. The two-layer bag can be a material-saving, environmentally friendly paper bag, while the three-layer paper bag can achieve higher strength and stability.

In another preferred embodiment, all material layers of the bag are made of paper or comparable biodegradable materials.

Advantageously, the bag according to the invention is fully compostable and/or recyclable. For example, such a bag can be disposed of directly by the consumer in an environmentally friendly manner on the home compost.

In a further preferred embodiment, the paper bag according to the invention is formed as a three-layer paper bag, wherein the outermost and innermost material layers are provided with a water-repellent layer on their outer faces. The central layer of such a bag may be formed of a particularly strong kraft paper. In such a bag construction, the strength and stability of the bag is provided mainly by the middle material layer, while the coatings on the innermost and outermost material layers ensure that the middle material layer does not become moist or soggy from the outside or inside and thus does not lose stability. Advantageously, the darkening color can be applied to the inner face of the middle layer.

The bag according to the invention can be configured as a bag with only one bottom, which is open at the top and is filled through this opening. The opening can be closed after filling, e.g. by suturing or bonding.

In another preferred embodiment, another bottom may be formed at the other end of the tube piece in addition to the one bottom so that the bag has two opposing bottoms. Advantageously, a valve for filling the bag can be inserted in one of the bottoms. An inner lining may also be inserted in the further bottom.

In another preferred embodiment, the ends of the tube piece are closed by suture. In this case, the folding or production of a bag bottom can be omitted. Such bags with sutured tube piece ends may be formed without a side gusset extending between the ends, or may be formed with at least one side gusset extending between the ends. Particularly preferred are two side folds extending between the ends of the bag and arranged opposite each other.

The invention also includes the use of a paper bag for packaging potting soil or similar moist bulk materials. According to widespread opinion among the skilled persons, moist bulk materials cannot be packed in paper bags because the moisture of the filling material soaks the paper bags, so that adequate stability is not ensured. In the course of the invention, it was found that, contrary to what is commonly assumed, it is nevertheless possible to reliably pack moist bulk materials such as potting soil in paper bags. Preferably, the invention comprises the use of an at least two-layer paper bag bonded with biodegradable adhesive, preferably starch glue, for packaging potting soil. Further preferably, the invention comprises using a paper bag according to one of claims 1 to 13 for packaging potting soil or similar moist bulk materials.

Example embodiments of the invention are explained in more detail with reference to the figures below. There are shown:

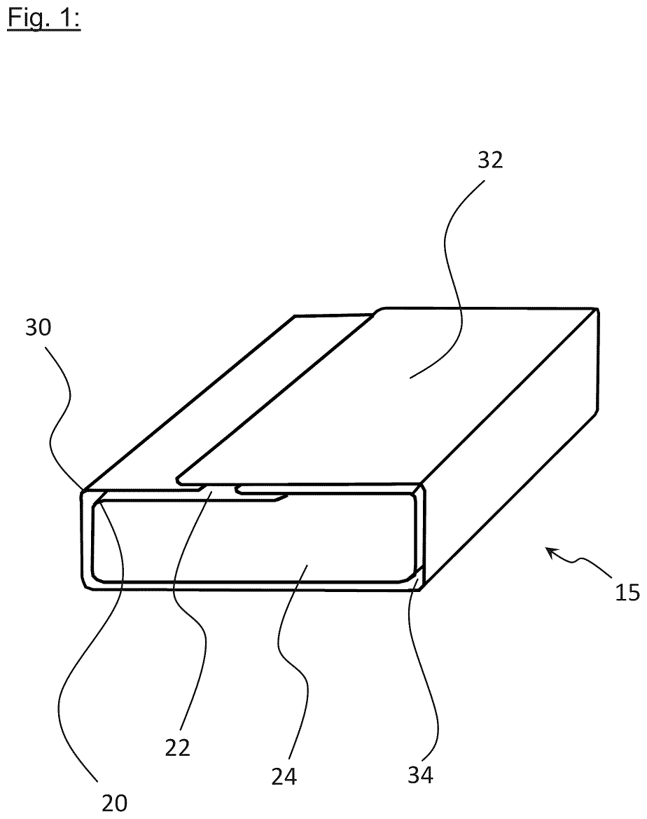

FIG. 1: The basic construction of a two-layer tube piece for the production of a bag according to the invention

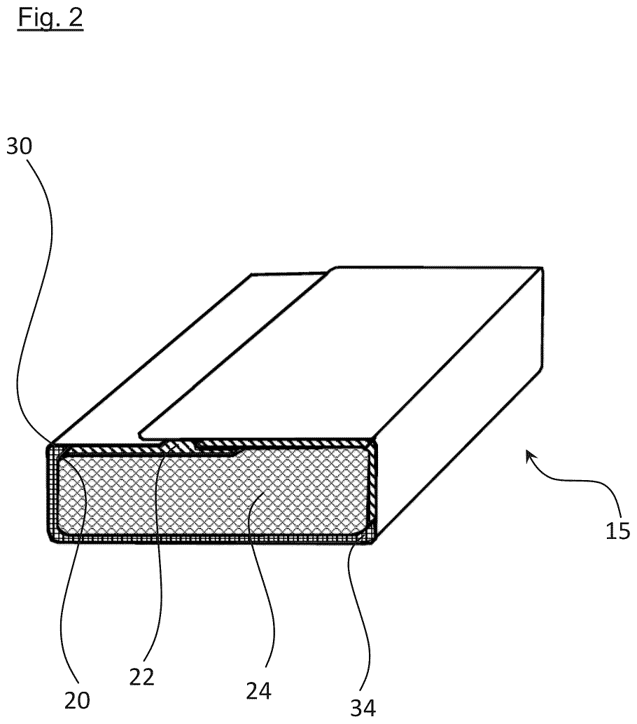

FIG. 2: A two-layer tube piece for the manufacture of a bag according to the invention

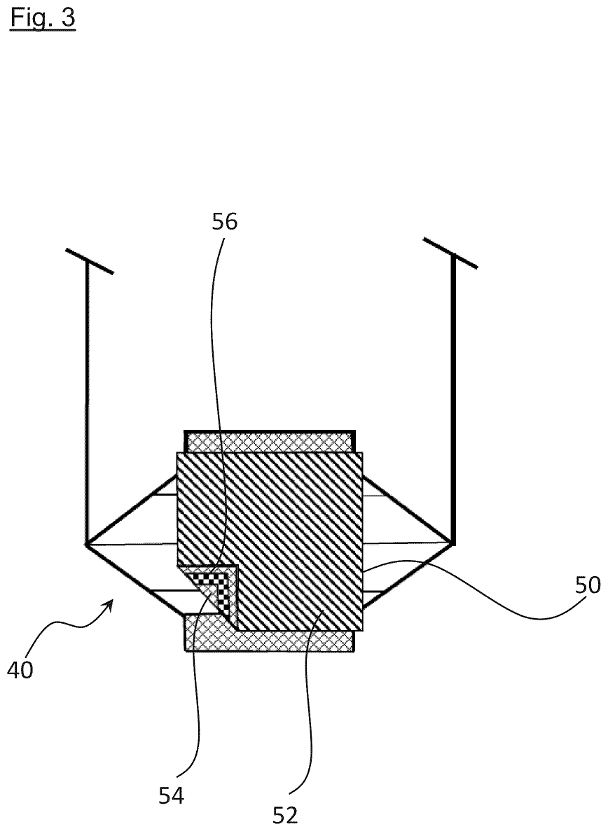

FIG. 3: The open cross bottom of a bag according to the invention with the inner lining in place

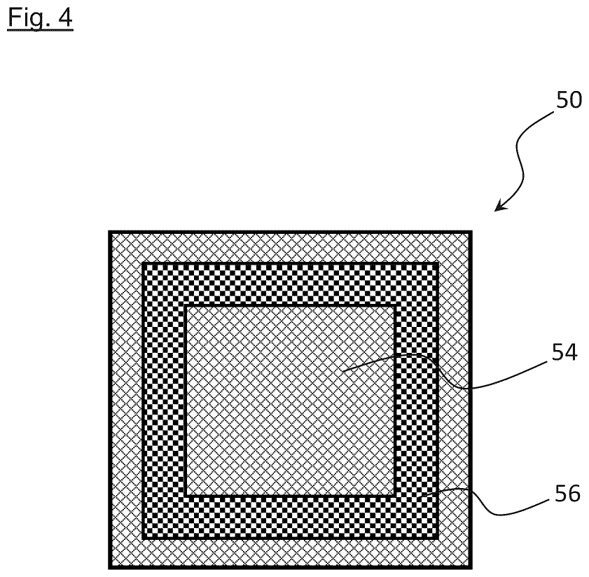

FIG. 4: An inner lining with adhesive contour

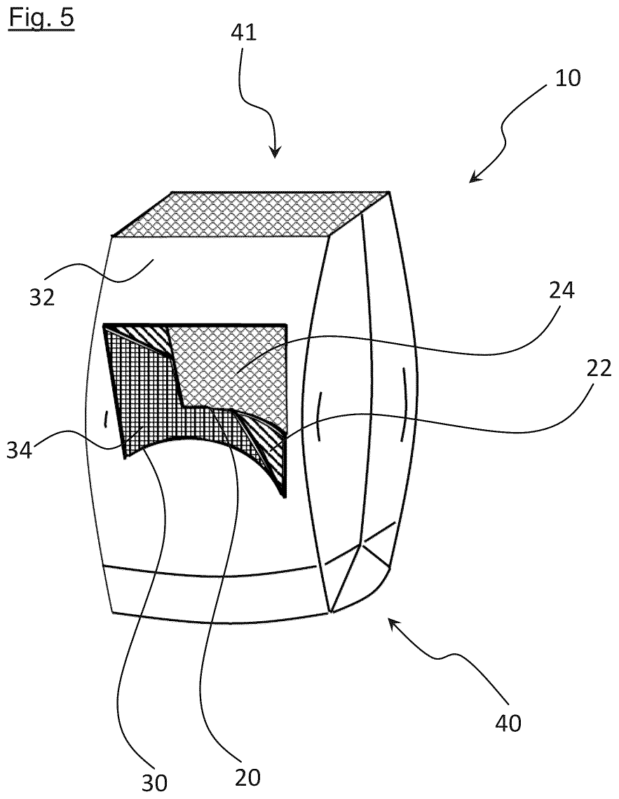

FIG. 5: A two-layer bag according to the invention which is open at the top.

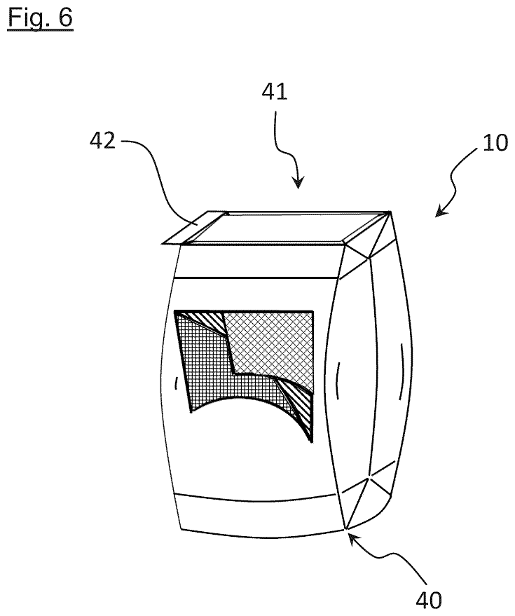

FIG. 6: A two-layer bag according to the invention with two opposite bottoms, the upper one of which is formed as a valve bottom

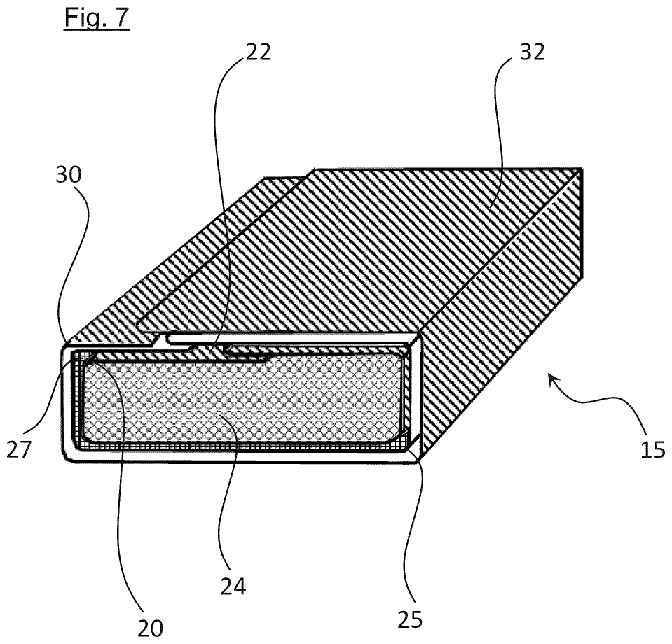

FIG. 7: A three-layer tube piece for the manufacture of a bag according to the invention

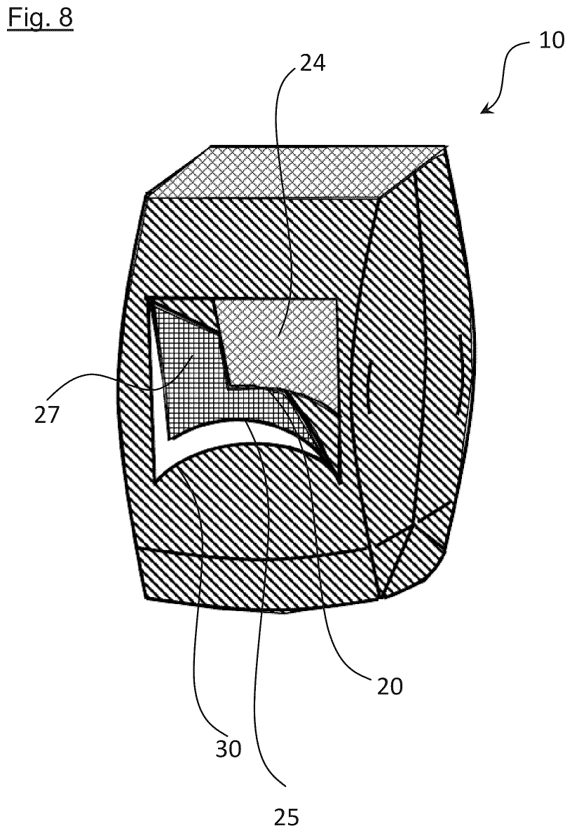

FIG. 8: A three-layer bag open at the top according to the invention

FIG. 1 shows the basic construction of a two-layer tube piece 15 for the production of the bags 10 according to the invention shown in FIGS. 5 and 6. The tube piece 15 shown in FIG. 1 is formed from an inner layer 20 and an outer layer 30 of paper, wherein the inner layer 20 has an outer face 22 facing away from the interior of the bag and an inner face 24 facing the interior of the bag. The outer layer 30 has an outer face 32 facing away from the interior of the bag and an inner face 34 facing toward the interior of the bag. As illustrated in FIG. 2, the outer face 22 of the inner layer 20 in this embodiment is provided with a water-repellent PE coating over its entire surface, which is shown in FIG. 2 with lined hatching. The inner face 24 of the inner layer 20 has an alkaline application and is coated with a fungicide, as shown in FIG. 2 with diagonal cross hatching. The inner face 34 of the outer layer 30 is printed with black ink, as shown in FIG. 2 with vertical and horizontal cross hatching. In an alternative embodiment, the alkaline application to the inner face 24 inner layer 20 may be omitted. In this embodiment, the inner face 24 of the inner layer 20 may be printed with black ink in addition to or instead of the inner face 34 of the outer layer 30.

FIG. 3 shows the open cross bottom 40 of a bag according to the invention, in which there is placed the inner lining 50. The inner face 54 of the inner lining 50, which rests on the open cross bottom 40 and faces the interior of the bag, is illustrated in FIG. 4. On the diagonally cross hatched inner face 54, the inner lining is provided with an alkaline application and also with a fungicide to prevent acid corrosion and molding in the filling material and in the bag material. Furthermore, the inner face 54 is provided with a frame-shaped adhesive contour 56 for gluing the inner lining 50 into the open cross bottom 40 of the bag 10 according to the invention. On the outer face 52 facing away from the interior of the bag, the inner lining 50 is provided with a water-repellent coating, which is shown in diagonally lined hatching in FIG. 3.

FIG. 5 shows a two-layer bag 10 according to the invention with a closed cross bottom 40 as a standing bottom. At the top 41 opposite the bottom, the bag is open for filling. After filling the bag 10 with potting soil, the opened top 41 can be closed by suture. The inner face 20 of the paper bag 10 has an alkaline application and a fungicide on its inner face 24 and a water-repellent PE coating on its outer face 22. The inner layer 20 and the outer layer 30 are made of paper. The outer layer 30 is printed in black on its inner face 34. On the outer face 32, the outer layer 30 may also be printed and/or coated, for example with a PE coating.

FIG. 6 shows a variant of a bag 10 according to the invention, in which a cross bottom is also formed on the upper side 41 opposite the standing bottom 40, into which a valve 42 is inserted for filling the bag.

FIG. 7 shows a three-layer tube piece 15 for making a three-layer bag 10 according to the invention, which is illustrated in more detail in FIG. 8. The inner layer 20 has an alkaline application and a fungicide on its inner face 24. Furthermore, inner layer 20 and outer layer 30 are each provided with a water-repellent PE coating on their outer faces 22 and 32, respectively. Between the inner layer 20 and the outer layer 30 of the bag is the intermediate layer 25, which is made of paper printed in black on its inner face 27. The additional material layer compared to a two layer bag can increase the stability and strength of the bag. In an alternative embodiment, the alkaline application to the inner face 24 of the inner layer 20 may be omitted.

With the paper bag according to the invention, moist potting soil can be packaged in a manner that is friendly to the environment and easy to handle, wherein the product properties of the potting soil filled in can be kept stable over relevant periods lasting from several weeks to months. In particular, the black printing on the inner face reduces light-induced biological activity in the potting soil. The fungicide applied on the inner face prevents molding in the potting soil and also in the bag material. The water-repellent PE coating on the outer face of the inner layer prevents, on the one hand, drying of the potting soil filled in, and on the other hand, the penetration of additional moisture from the outside, which would make the potting soil filled in heavier. In addition, by preventing water from leaking out of the potting soil, the outer layer of the bag material can be kept dry and stable.

1. A paper bag (10) for potting soil or comparable moist bulk materials, formed from a tubular piece (15) comprising at least two paper layers (20, 25, 30), the bonds of the bag (10) being formed with biodegradable adhesive, wherein the innermost paper layer (20) of the tubular piece (15) has on its outer face (22) a water-repellent coating, preferably a PE coating, and at least one of the paper layers (20, 25, 30) has at least on its inner face (24, 27, 34) a darkening colouring, preferably black colouring.

2. A paper bag according to claim 1, wherein the bag has a bottom (40) at one end of the tubular piece, preferably a cross bottom, block bottom or pinch bottom.

3. The paper bag according to claim 1, wherein an inner lining (50) preferably formed of paper is inserted into the bottom (40), and the inner lining (50) is provided with a water-repellent coating, preferably a PE coating, on the outer face (52) facing away from the interior of the bag and/or the inner lining has a darkening colouring, preferably black colouring at least on its inner face (54) facing the interior of the bag.

4. The paper bag according to claim 1, wherein the biodegradable adhesive contains starch glue, preferably potato starch glue, and/or a moisture-stable bonding additive, preferably dispersion glue, is admixed to the biodegradable adhesive.

5. The paper bag according to claim 4, wherein the moisture-stable bonding additive is admixed to the biodegradable adhesive with a content of not more than 10% by weight, preferably not more than 7% by weight.

6. A paper bag according to claim 1, wherein the bonding regions of the bag material have no coatings reducing the adhesion and/or are bonded with a water-resistant adhesive component.

7. The paper bag according to claim 1, wherein the inner face (24) of the innermost paper layer (20) and/or the inner face (54) of the inner lining (50) in contact with the filling material are treated with a preferably natural fungicide and/or an antimicrobially acting substance and/or provided with an alkaline application.

8. The paper bag according to claim 1, wherein the water-repellent paper coatings are implemented as free of plastic, biodegradable, compostable and/or recyclable coatings.

9. The paper bag according to claim 1, wherein all material layers (20, 25, 30) of the bag are composed of paper and/or comparable biodegradable materials.

10. The paper bag according to claim 1, wherein the bag is fully compostable and/or recyclable.

11. The paper bag according to claim 1, wherein the bag is formed as a three-layer paper bag, and the outermost material layer (30) is preferably provided on its outer face with a water-repellent, biodegradable, compostable and/or recyclable coating.

12. The paper bag according to claim 1, wherein the bag is closed at one end of the tubular piece by suture or a bottom is formed at both ends of the tubular piece, preferably a cross bottom, block bottom or pinch bottom, and preferably a valve is inserted in one bottom for filling the bag.

13. The paper bag according to claim 1, wherein the bag is closed at both ends of the tubular piece by suture and the tubular piece is formed without or with a side fold extending between the ends.

14. The paper bag according to claim 3, wherein the biodegradable adhesive contains starch glue, preferably potato starch glue, and/or a moisture-stable bonding additive, preferably dispersion glue, is admixed to the biodegradable adhesive.

15. The paper bag according to claim 2, wherein the biodegradable adhesive contains starch glue, preferably potato starch glue, and/or a moisture-stable bonding additive, preferably dispersion glue, is admixed to the biodegradable adhesive.

16. The paper bag according to claim 15, wherein the moisture-stable bonding additive is admixed to the biodegradable adhesive with a content of not more than 10% by weight, preferably not more than 7% by weight.

17. The paper bag according to claim 14, wherein the moisture-stable bonding additive is admixed to the biodegradable adhesive with a content of not more than 10% by weight, preferably not more than 7% by weight.

18. A paper bag according to claim 17, wherein the bonding regions of the bag material have no coatings reducing the adhesion and/or are bonded with a water-resistant adhesive component.

19. A paper bag according to claim 16, wherein the bonding regions of the bag material have no coatings reducing the adhesion and/or are bonded with a water-resistant adhesive component.

20. A paper bag according to claim 14, wherein the bonding regions of the bag material have no coatings reducing the adhesion and/or are bonded with a water-resistant adhesive component.
